(19) United States
(12) Patent Application Publication
(10) Pub. No.: US 2007/0239534 A1
(43) Pub. Date: Oct. 11, 2007

(54) Method and apparatus for selecting advertisements to serve using user profiles, performance scores, and advertisement revenue information

(76) Inventors: Hongche Liu, Fremont, CA (US); Long-Ji Lin, San Jose, CA (US)

Correspondence Address: Stattler-Suh PC, 60 SOUTH MARKET, SUITE 480, SAN JOSE, CA, 95113, US

(21) Appl. No.: 11/394,248

(22) Filed: Mar. 29, 2006

(51) Int. Cl. G06Q 30/00

(52) U.S. Cl. 705/14

(57) ABSTRACT

A method and apparatus for selecting additional content to display to a user when the user requests base content is provided. A user profile of the user having user interest scores of categories or keywords is received, each user interest score reflecting the degree of interest the user has in the category or keyword. Performance scores reflecting the probability that a user having particular user interest scores will select additional content associated with particular categories or keywords is also received. In addition, revenue amounts associated with each category or keyword of the user profile is received. The user interest scores, performance scores, and revenue amounts are used to produce an expected revenue amount for each category or keyword in the user profile. Additional content to be sent to the user is then selected using the determined expected revenue amounts.

### FIELD OF THE INVENTION

The present invention is directed towards a method and apparatus for selecting advertisements to serve using user profiles, performance scores, and advertisement revenue information.

### BACKGROUND OF THE INVENTION

When a user makes a request for base content to a server via a network, additional content is also typically sent to the user along with the base content. The user can be a human user interacting with a user interface of a computer that transmits the request for base content. The user could also be another computer process or system that generates and transmits the request for base content programmatically.

Base content might include a variety of content provided to a user and presented, for example, on a published web page. For example, base content might include published information, such as articles, about politics, business, sports, movies, weather, finance, health, consumer goods, etc. Additional content might include content that is relevant to the base content or a user. For example, relevant additional content that is relevant to the user might include advertisements for products or services in which the user has an interest.

Base content providers receive revenue from advertisers who wish to have their advertisements displayed to users and pay a particular amount each time a user clicks on one of their advertisements. Base content providers employ a variety of methods to determine which additional content to display to a user. For example, the user's interest in particular subject categories may be used to determine which additional content to display to the user. Typically, however, base content providers do not consider the expected revenue generation in determining which additional content to display.

### SUMMARY OF THE INVENTION

A method and apparatus for selecting additional content to display to a user when the user requests base content is provided. A user profile associated with the user having user interest scores of particular subject categories is received, each user interest score reflecting the degree of interest the user has in the subject category. Performance scores reflecting the probability/propensity that a user will select additional content associated with particular categories is also received. In some embodiments, the performance scores reflect the probability that a user having particular user interest scores will select additional content associated with particular categories. In other embodiments, the performance scores reflect the probability that a user meeting particular behavior parameters will select additional content associated with particular categories. In addition, revenue amounts associated with each category of the user profile is received.

The user interest scores, performance scores, and revenue amounts are then used to produce an expected revenue amount for each category in the user profile (e.g., by multiplying the performance score and revenue amount for each category). A revenue-optimized list of additional content for the user is then produced using the calculated expected revenue amounts. In some embodiments, the revenue-optimized list comprises a set of additional content associated with the category having the highest expected revenue amount in the user profile.

In an alternative embodiment, the expected revenue amount and the revenue-optimized list is produced on a per keyword basis rather than a per category basis. In the alternative embodiment, some or all of the information received and used is generated on a per keyword basis rather than a per category basis. For example, user interest scores may be generated for individual keywords of various categories and stored in the user profile, performance scores may be generated for individual keywords based on the user interest score of the keywords, and revenue amounts can be determined for individual keywords of categories. Using the keyword-based information, the expected revenue amount for each keyword is determined and the additional content associated with the keyword having the highest revenue amount is sent to the user.

### BRIEF DESCRIPTION OF THE DRAWINGS

The novel features of the invention are set forth in the appended claims. However, for purpose of explanation, several embodiments of the invention are set forth in the following figures.

FIG. 1 shows a network environment in which some embodiments operate.

FIG. 2 shows a conceptual diagram of a revenue-optimization system.

FIG. 3 shows a conceptual diagram of an exemplary user profile comprising a plurality of user interest vectors.

FIG. 4 shows a conceptual diagram of exemplary aggregated performance data comprising performance scores.

FIG. 5 shows a chart of performance scores determined for the exemplary user profile of FIG. 3 using the exemplary aggregated performance data of FIG. 4.

FIG. 6 shows an exemplary chart of category revenue amounts that have been determined for the categories of the exemplary user profile of FIG. 3.

FIG. 7 shows an exemplary chart of category expected revenue amounts determined for the exemplary user profile of FIG. 3.

FIG. 8 shows an exemplary chart of keyword expected revenue amounts determined for an exemplary user profile.

FIG. 9 is a flowchart of a method for selecting additional content based on expected revenue amounts of the additional content.

FIG. 10 presents a computer system with which some embodiments are implemented.

### DETAILED DESCRIPTION

The disclosure of U.S. Patent Application entitled “A Behavioral Targeting System,” Attorney Docket No. YHOO.P0003, Express Mail Label No. EV 827969546 US, filed concurrently herewith, is expressly incorporated herein by reference.

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

A method and apparatus for selecting additional content to display to a user when the user requests base content is provided. A user profile associated with the user having user interest scores of particular subject categories is received, each user interest score reflecting the degree of interest the user has in the subject category. Performance scores reflecting the probability/propensity that a user will select additional content associated with particular categories is also received. In some embodiments, the performance scores reflect the probability that a user having particular user interest scores will select additional content associated with particular categories. In other embodiments, the performance scores reflect the probability that a user meeting particular behavior parameters will select additional content associated with particular categories. In addition, revenue amounts associated with each category of the user profile is received.

The user interest scores, performance scores, and revenue amounts are then used to produce an expected revenue amount for each category in the user profile (e.g., by multiplying the performance score and revenue amount for each category). A revenue-optimized list of additional content for the user is then produced using the calculated expected revenue amounts. In some embodiments, the revenue-optimized list comprises a set of additional content associated with the category having the highest expected revenue amount in the user profile.

In an alternative embodiment, the expected revenue amount and the revenue-optimized list is produced on a per keyword basis rather than a per category basis. In the alternative embodiment, some or all of the information received and used is generated on a per keyword basis rather than a per category basis. For example, user interest scores may be generated for individual keywords of various categories and stored in the user profile, performance scores may be generated for individual keywords based on the user interest score of the keywords, and revenue amounts can be determined for individual keywords of categories. Using the keyword-based information, the expected revenue amount for each keyword is determined and the additional content associated with the keyword having the highest revenue amount is sent to the user.

As used herein, base content is content requested by a user. Base content may be presented, for example, as a web page and may include a variety of content (e.g., news articles, emails, chat-rooms, etc.). Base content may be in a variety of forms including text, images, video, audio, animation, program code, data structures, hyperlinks, etc. The base content may be formatted according to the Hypertext Markup Language (HTML), the Extensible Markup Language (XML), Standard Generalized Markup Language (SGML), or any other language.

As used herein, additional content is content that is sent to the user along with the requested base content. Additional content might include content that is relevant to the base content or a user. Additional content may include, for example, an advertisement or hyperlink (e.g., sponsor link, integrated link, inside link, or the like) in which the user has an interest. Additional content may include a similar variety of content and form as the base content described above.

As used herein, a base content provider is a network service provider (e.g., Yahoo! News, Yahoo! Music, Yahoo! Finance, Yahoo! Movies, Yahoo! Sports, etc.) that operates one or more servers that contain base content and receives requests for and transmits base content. A base content provider also sends additional content to users and employs methods for determining which additional content to send along with the requested base content, the methods typically being implemented by the one or more servers it operates.

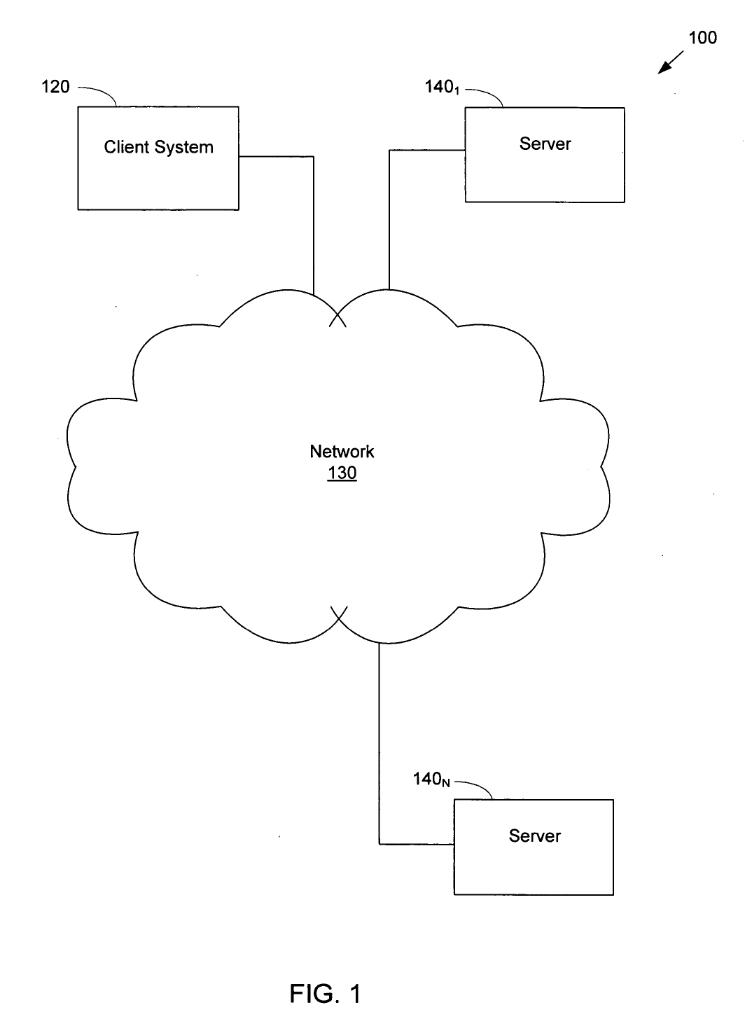

FIG. 1 shows a network environment 100 in which some embodiments operate. The network environment 100 includes a client system 120 coupled to a network 130 (such as the Internet or an intranet, an extranet, a virtual private network, a non-TCP/IP based network, any LAN or WAN, or the like) and server systems 140₁ to ¹⁴⁰_{N}. A server system may include a single server computer or number of server computers. The client system 120 is configured to communicate with any of server systems 140₁ to 140_{N}, for example, to request and receive base content and additional content (e.g., in the form of a web page).

The client system 120 may include a desktop personal computer, workstation, laptop, PDA, cell phone, any wireless application protocol (WAP) enabled device, or any other device capable of communicating directly or indirectly to a network. The client system 120 typically runs a web browsing program (such as Microsoft's Internet Explorer™ browser, Netscape's Navigator™ browser, Mozilla™ browser, Opera™ browser, a WAP-enabled browser in the case of a cell phone, PDA or other wireless device, or the like) allowing a user of the client system 120 to request and receive content from server systems 140₁ to 140_{N} over network 130. The client system 120 typically includes one or more user interface devices 22 (such as a keyboard, a mouse, a roller ball, a touch screen, a pen or the like) for interacting with a graphical user interface (GUI) of the web browser on a display (e.g., monitor screen, LCD display, etc.).

In some embodiments, the client system 120 and/or system servers 140₁ to 140_{N} are configured to perform the methods described herein. The methods of some embodiments may be implemented in software or hardware configured to optimize the selection of additional content to be displayed to a user.

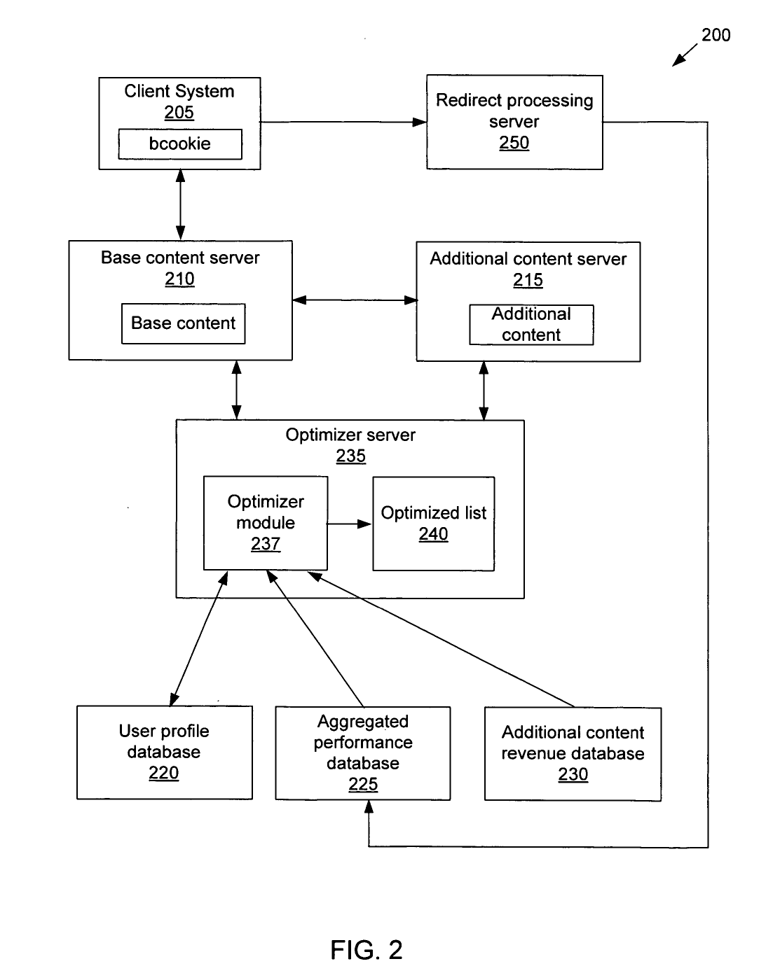

FIG. 2 shows a conceptual diagram of a revenue-optimization system 200. The revenue-optimization system 200 includes a client system 205, a base content server 210 (containing base content), an additional content server 215 (containing additional content), a database of user profiles 220, a database of aggregated performance data 225, a database of additional content revenue information 230, an optimizer server 235, and a redirect processing server 250. The optimizer server 235 comprises an optimizer module 237 that receives information from the various databases 220, 225, and 235 to determine a revenue-optimized list of additional content 240. The revenue-optimization system 200 is configured to select additional content to be sent to a user that maximizes expected revenue generation for a base content provider. Various portions of the revenue-optimization system 200 may reside in one or more servers (such as servers 140₁ to 140_{N}) and/or one or more client systems (such as client system 120).

The client system 205 is configured to send a request for base content to the base content server 210, receive base content and additional content from the base content server 210, display the base and additional content to the user (e.g., as a published web page), and receive selections of additional content from the user (e.g., through a user interface). In some embodiments, the client system 205 is also configured to send to the redirect processing server 250 performance data regarding the number of times particular additional content has been displayed and selected on the client system 205.

The user profile database 220 stores user profiles for a plurality of users, each user profile having a unique user-identification number assigned for a particular client system 205 used by a user. The user-identification number may be stored, for example, in a bcookie on the client system 205 used by the user. When a user requests a piece of base content from a base content server 210, the bcookie is transferred from the client system 205 to the base content server 210 and then to the optimizer server 235. The optimizer server 235 then uses the user-identification number in the bcookie to retrieve the particular user profile from the user profile database 220.

A user profile contains one or more subject category interest scores for a user. In some embodiments, a list of possible subject categories for which interest scores are calculated are predetermined. A subject category interest score reflects the level/degree of interest the particular user has in the particular subject category. In some embodiments, a subject category interest score reflects the level/degree of interest the particular user has in purchasing a product or service related to the particular subject category. For example, a user profile may contain interest scores for the subject categories of “cars,” “vacations,” “finance,” and “movies” for a user.

The category interest scores are sometimes referred to as relevance scores and are based on data for the user that is collected using any variety of methods. Detail regarding the generation of category interest scores used in some embodiments is discussed in the U.S. Patent Application entitled “A Behavioral Targeting System,” Attorney Docket No. YHOO.P0003, Express Mail Label No. EV 827969546 US, filed concurrently herewith, which is expressly incorporated herein by reference.

In some embodiments, the category interest/relevance scores is based on user data collected by extracting keywords from past or present base content or search queries requested by the user. As used herein, a keyword can comprise a single word (e.g., “cars,” “television,” etc.) or a plurality of words (e.g., “car dealer,” “New York City,” etc.). In these embodiments, each category has an associated predetermined set of keywords. For example, the category of “cars” may have associated keywords “sports car,” “car dealer,” “car accessories,” etc. Each keyword of a category has an associated bid/revenue amount and an associated additional content. As such, each category also has an associated set of revenue amounts and an associated set of additional content. In some embodiments, advertisers bid on keywords of a category and agree to pay a bid/revenue amount to a base content provider if their piece of additional content is displayed when the particular keyword is extracted from base content or search queries requested by the user. Alternatively, an advertiser may agree to pay the bid/revenue amount only if their piece of additional content is selected (clicked on) by the user after being displayed.

The higher the number of keywords associated with a particular category that are extracted from base content or search queries requested by the user, the higher the interest/relevance score for that particular category will be. The category interest scores in a user profile are updated as the user requests new base content or search queries and keywords are extracted from the new base content or search queries. In other embodiments, the category interest/relevance scores are based on data collected for the user using other methods.

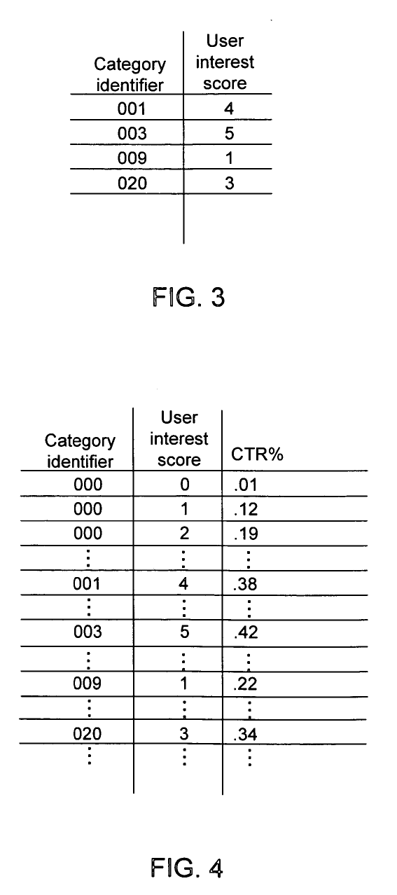

In some embodiments, a user profile contains one or more category interest scores for a user in the form of user interest vectors, each user interest vector comprising a unique category identifier and a corresponding user interest score. FIG. 3 shows a conceptual diagram of an exemplary user profile comprising a plurality of user interest vectors, each user interest vector comprising a unique category identifier and a corresponding user interest score. For example, FIG. 3 shows a first user interest vectors having a category identifier 001 and a user interest score of 4, a second user interest vectors having a category identifier 003 and a user interest score of 5, etc. For illustration purposes, the user interest scores are shown in FIGS. 3 through 8 as discrete integer values. The user interest scores, however, can be represented in any form, such as floating point values.

The database of aggregated performance data 225 contains statistical data of users' behavior regarding rates of selecting pieces of additional content (e.g., by clicking on the additional content) associated with a category per number of viewings of the pieces of additional content. In general, the ratio of the number of selections of an additional content to the number of viewings or servings of the additional content is referred to as the performance score or click-through-rate (CTR) of the additional content. The performance score (CTR) of a piece of additional content reflects the probability or propensity that a particular user will click on the additional content upon viewing or being served the additional content to view content associated with the additional content (e.g., a page or site pointed at by a link included in the additional content). For example, a 0.5% CTR means there is a 5 in 1000 chance (based on prior collected statistical data) the user will select the additional content upon viewing it.

As discussed above, a performance score can be determined for each category. Each category also has an associated set of additional content. For example, a “car” category may have an associated set of additional content comprising advertisements or links for various brands of cars, car dealers, car accessories, etc. A performance rate for a category reflects the ratio of the number of selections of additional content associated with the category to the number of viewings of the additional content.

Further, a performance score can be determined for a particular user interest score of a particular category. This performance score reflects, for users having the particular user interest score for the particular category, the ratio of the number of selections of additional content associated with the category to the number of viewings of the additional content. For example, a performance score of 0.35% for a user interest score of 4 for the “car” category indicates that, statistically, for users with a user interest score of 4, there is a 0.35% chance that the user will click on a piece of additional content associated with the “car” category upon viewing the additional content. The data used in determining the performance scores for various user interest scores of various categories may be aggregated from a plurality of users and updated as further viewings and/or selections are made by users. In some embodiments, the aggregated performance data includes a performance score (CTR %) for each possible user interest score of each predetermined subject category. FIG. 4 shows a conceptual diagram of exemplary aggregated performance data comprising a performance score (CTR %) for the user interest scores of 0, 1, 2, 3, etc. for each of categories 000, 001, 002, 003, etc.

Typically, the performance data regarding the number of viewings and selections of additional content is aggregated from a plurality of users and is updated as further viewings and/or selections are made by the users. In some embodiments, the performance data is updated using a feedback loop between the client system 205, the redirect processing server 250, and the database of aggregated performance data 225. As new viewings and selections of additional content by the user are made on the client system 205, data regarding these new viewings and selections are received and collected by the redirect processing server 250 and then used to update one or more performance scores of the aggregated performance database 225 accordingly.

In some embodiments, the performance score of a particular category and a particular interest score is determined statistically by determining the number of selections of additional content associated with the particular category per number of viewings of the additional content by users having the particular interest score in the particular category. In these embodiments, “per interest score” data is collected in the aggregated performance database 225 regarding past viewings and selections of additional content by users for each category at each interest score to determine performance scores for each category at each interest score level. Typically, the performance score of a piece of additional content is based on a statistically significant amount of collected data.

In an alternative embodiment, a performance score for a particular user and category is based on alternative data collected in the aggregated performance database 225 (e.g., when there is not enough collected “per interest score” data to determine performance scores for each category at each interest score level). In the alternative embodiment, a performance score for a particular user is based on behavior data collected from a plurality of past users who have selected additional content associated with a particular category. This collected data shows the past behavior of users who have selected the additional content—such as the number of times users performed a particular search query, visited a particular type of web page, or selected a particular type of link—before the users selected the particular additional content. Performance scores for a particular category and a particular user meeting these particular behavior parameters can then be determined using the collected behavior data.

For example, behavior data collected from a plurality of past users may illustrate behavior parameters for the category “foreign cars.” For example, for 1000 past users who performed a search query for “foreign cars” (behavior parameter 1) and also visited a foreign car website (behavior parameter 2), when then shown additional content associated with the category “foreign cars,” 10 of the 1000 users selected the additional content which produces a 1% CTR of the past users. Therefore, for the “foreign cars” category for a new user who meets the conditions of the two behavior parameters (i.e., has performed a search query for “foreign cars” and visited a foreign car website), there is an associated 1% performance score/CTR which reflects a 1% probability that the new user will select an additional content associated with the category “foreign cars.”

As such, in the alternative embodiment, a performance score for a particular category and user reflects the probability/propensity that a user meeting particular behavior parameters will select additional content associated with the category upon viewing the additional content. A performance score/CTR based on behavior parameters of past users is sometimes referred to as a “predictive” performance score/CTR (since it predicts the behavior of a new user meeting the behavior parameters). Detail regarding “predictive” performance score/CTR used in some embodiments is discussed in the U.S. Patent Application entitled “A Behavioral Targeting System,” which is referenced above.

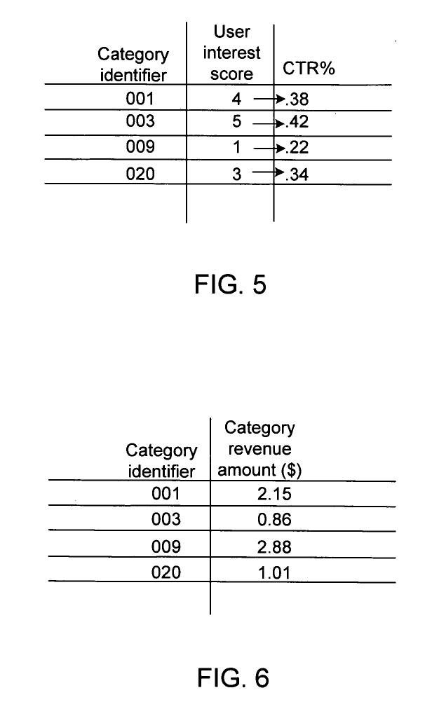

The user profiles and aggregated performance data are received by the optimizer module 237 of the optimizer server 235. The optimizer module 237 determines a performance score for each category in a user profile using the aggregated performance data (e.g., by looking up the performance score in the aggregated performance data corresponding to the user interest score of the category). FIG. 5 shows a chart of performance scores determined for the exemplary user profile of FIG. 3 using the exemplary aggregated performance data of FIG. 4. As shown in FIG. 5, using the exemplary aggregated performance data of FIG. 4., category 001 having a user interest score of 4 maps to a performance score of 0.38%, category 003 having a user interest score of 5 maps to a performance score of 0.42%, etc. In other embodiments, “predictive” performance scores are determined for each category of the exemplary user profile of FIG. 3. In further embodiments, a performance score for each user interest score of a category in a user profile is determined beforehand and stored in the user profile.

As discussed above, each subject category has an associated set of keywords, each keyword having an associated bid/revenue amount and an associated additional content. The associated bid/revenue amount is typically the amount that an advertiser has bid on the keyword and has agreed to pay to a base content provider if the associated additional content (their additional content) is displayed and selected (clicked on) by a user. Typically the advertiser with the highest bid on a keyword “purchases” the keyword. For example, keywords may be bid on by advertisers through the Overture™ auction system. As such, each category also has an associated set of revenue amounts and an associated set of additional content.

In some embodiments, the database of additional content revenue information 230 comprises data regarding bid/revenue amounts for various subject categories and/or various keywords of each subject category. The advertisement revenue information is received by the optimizer module 237 of the optimizer server 235. The advertisement revenue information may be received, for example, from the Overture™ auction system. In some embodiments, the optimizer module 237 receives or determines a category revenue amount for each subject category of a received user profile. The category revenue amount considers the revenue amounts associated with the keywords of the category and reflects the average/typical revenue amount generated per selection (“click”) of a piece of additional content associated with the category. FIG. 6 shows an exemplary chart of category revenue amounts that have been determined for the categories 001, 003, 009, and 020 of the exemplary user profile of FIG. 3.

The category revenue amounts for the various subject categories can be determined through a variety of methods. In some embodiments, the category revenue amount for a subject category is determined by averaging the revenue amounts of the keywords associated with the subject category. For example, assume that the category 001 has 3 associated keywords with revenues of $0.50, $1.20, and $0.85. The category revenue amount of category 001 would then be (0.50+1.20+0.85)/3 which is equal to $0.85.

In other embodiments, the category revenue amount for a subject category is determined by considering the probabilities (i.e., popularity or rate of occurrence) that particular keywords of the subject category will be extracted (e.g., from base content or search queries) relative to the other keywords in the same subject category (i.e., the number of times the particular keyword is extracted divided by the number of times all keywords in the category are extracted). In these embodiments, each keyword revenue amount is multiplied by a weight value that reflects the probability that the keyword will be extracted/searched relative to the other keywords in the category.

For example, assume the “car” category has only two associated keywords “car dealer” and “car test drive.” The keyword “car dealer” may have an associated revenue amount of $0.50 and a 1000/1100 probability of being extracted relative to the other keywords in the category (i.e., the number of times the keyword “car dealer” is extracted divided by the number of times all keywords in the “car” category are extracted). Also, the keyword “car test drive” may have an associated revenue amount of $4.50 and a 100/1100 probability of being extracted relative to the other keywords in the category. This shows that the keyword “car dealer” is a relatively popular keyword (is extracted often) but has a relatively low revenue amount and the keyword “car test drive” is a relatively unpopular keyword (is not extracted often) but has a relatively high revenue amount. The category revenue amount for the “car” category would then be: [($0.50×1000)+($4.50×100)]/1100 which is equal to $0.86. Thus the category revenue amount reflects the revenue amount generated per keyword extraction for the category. The probability/weighting values for each keyword may be determined statistically by aggregated data of user behavior. As discussed above, the optimizer module 237 of the optimizer server 235 receives user profiles from the database of user profiles 220, performance scores from the database of aggregated performance data 225, and revenue amounts from the database of additional content revenue information 230. Using the received information, the optimizer module 237 then determines the expected revenue amount for each category of a user profile, the expected revenue amount for a category reflecting the probable revenue amount that would be generated by displaying a piece of additional content associated with the category to a user (which is displayed along with the base content requested by the user). In some embodiments, the expected revenue amount for a category is determined by multiplying the performance score of the category (e.g., as determined by the user interest score) and the category revenue amount.

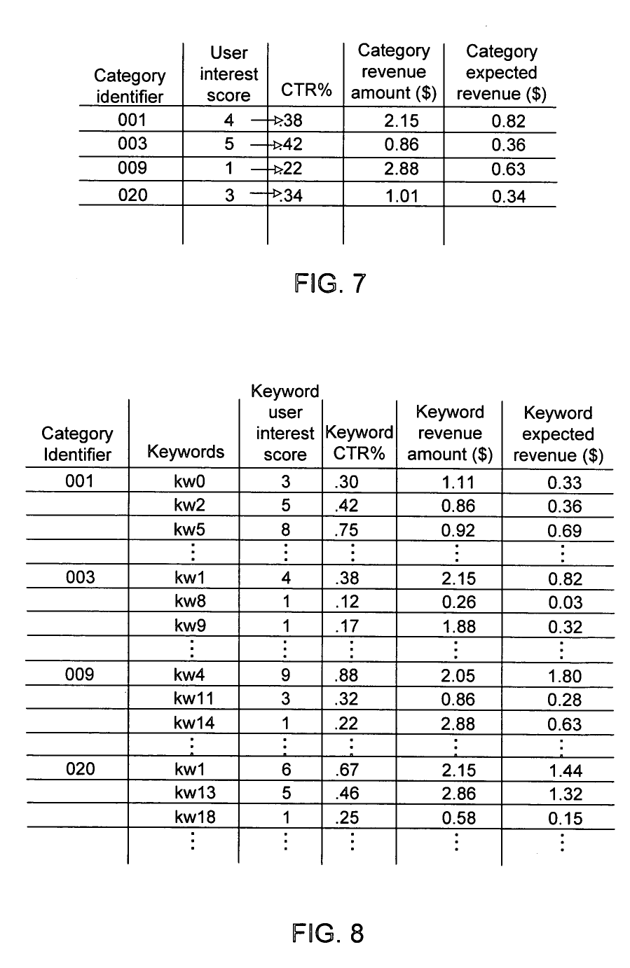

FIG. 7 shows an exemplary chart of category expected revenue amounts determined for the exemplary user profile of FIG. 3 using the exemplary aggregated performance data of FIG. 4 and the exemplary category revenue amounts of FIG. 6. Each category in the user profile maps to a particular performance score for the category (e.g., based on user interest scores or behavior parameters). The performance score for each category of the user profile is then multiplied by the revenue amount calculated for the category to produce the expected revenue amount for the category which reflects the probable revenue amount generated by displaying a piece of additional content associated with the category to a user.

The optimizer module 237 then creates a revenue-optimized list of additional content 240 using the expected revenue amounts for the categories in the user profile. In some embodiments, the revenue-optimized list of additional content comprises the set of additional content associated with the category having the highest expected revenue amount in the user profile. In other embodiments, the revenue-optimized list of additional content comprises a set of unique identifiers that identify a set of additional content, the set of unique identifiers being used to retrieve the set of additional content (e.g., from the additional content server 215). In the example shown in FIG. 7, the revenue-optimized list of additional content would comprise the additional content (or unique identifiers for the additional content) associated with category 001 since it has the highest expected revenue amount in the user profile. The optimizer module 237 then sends the revenue-optimized list of additional content to the base content server 210. The base content server 210 then retrieves the requested base content, retrieves one or more pieces of additional content on the revenue-optimized list from the additional content server 215, and sends the base content and one or more pieces of additional content to the client system 205.

As described above, even if a particular category in a user profile has the highest user interest and performance score in the user profile, additional content of the particular category may still not be sent to the user after considering the revenue amount generated by the particular category (if the category revenue amount is relatively low and thus the expected revenue is relatively low). On the other hand, even if a particular category in a user profile has the highest revenue amount in the user profile, the additional content of the particular category may still not be sent to the user after considering the performance score of the particular category (if the probability of the user selecting the additional content is relatively low and thus the expected revenue is relatively low). Rather, the optimizer module 237 determines which category's additional content to send to a user by weighing the probability of the user selecting the additional content (as reflected in the performance score) and the revenue generated if the user does in fact select the additional content.

In an alternative embodiment, the optimizer module 237 determines the expected revenue amount and the revenue-optimized list 240 on a per keyword basis rather than a per category basis. In the alternative embodiment, some or all of the information received and used by the optimizer module 237 may be generated on a per keyword basis rather than a per category basis. For example, user interest scores may be generated for individual keywords of each category and stored in the user profile, performance scores may be generated for individual keywords based on user interest scores of the keywords, and/or revenue amounts can be determined for individual keywords of categories rather than for the entire category. Using the keyword-based information, the optimizer module 237 can determine expected revenue amounts for individual keywords and send the additional content associated with the keyword having the highest revenue amount to the user (where the revenue-optimized list 240 comprises this additional content).

JF[IG. 8 shows an exemplary chart of keyword expected revenue amounts determined for an exemplary user profile having user interest scores for individual keywords (represented as kw0, kw2, kw5, etc.) of categories. The keyword expected revenue amounts of the chart of FIG. 8 are determined using the keyword user interest scores, keyword aggregated performance data (CTR %), and keyword revenue amounts. The user interest scores for each keyword in the user profile maps to a particular performance score for the interest score and keyword (e.g., based on statistical data aggregated from a plurality of users). The performance score for each keyword of the user profile is then multiplied by the revenue amount calculated for the keyword to produce the expected revenue amount for the keyword which reflects the probable revenue amount generated by displaying a piece of additional content associated with the keyword to a user. In the example of shown in FIG. 8, the revenue-optimized list of additional content would comprise the additional content associated with keyword 4 of category 009 (since it has the highest expected revenue amount in the user profile) which is then sent to the client system 205 along with the requested base content.

The information received and used by the optimizer module 237 can be a mix of information generated on a per keyword basis and information generated on a per category basis. For example, the user interest scores may be generated for categories rather than individual keywords where a category user interest score is then applied to all keywords of the category. The performance score and revenue amounts can then still be generated on a per keyword basis using the category user interest score that is applied to all keywords of a category. For example, although each keyword of a category would have the same user interest score, different performance scores or revenue amounts can be determined for the individual keywords of the category. As a further example, assume the optimizer module 237 receives user interest and performance scores on a per category basis but receives revenue amounts on a per keyword basis. The optimizer module 237 then multiplies the per category performance score with the individual keyword revenue amounts to determine the expected revenue amount for individual keyword.

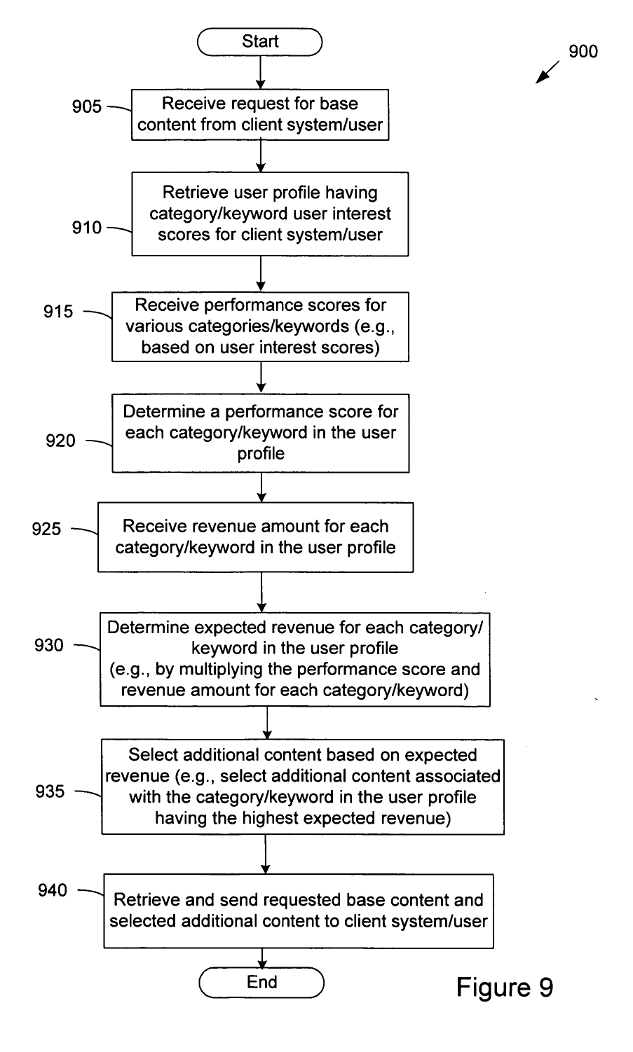

FIG. 9 is a flowchart of a method 900 for selecting additional content based on expected revenue amounts of the additional content. In some embodiments, the method 900 is implemented by software or hardware configured to select the additional content. In some embodiments, the steps of method 900 are performed by one or more servers (such as servers 140₁ to 140_{N}) and/or one or more client systems (such as client system 120). The order and number of steps of the method 900 are for illustrative purposes only and, in other embodiments, a different order and/or number of steps are used.

The method 900 begins when a request for base content is received (at 905) from a client system/user. The method 900 then retrieves (at 910) a user profile associated with the client system/user (e.g., from a user profile database using a user-identification number). In some embodiments, the user profile contains user interest scores for various subject categories that reflect the user's interest in the particular subject categories. In other embodiments, the user profile contains user interest scores for various keywords of subject categories that reflect the user's interest in the particular keywords. Each category or keyword of the user profile has associated additional content and an associated revenue amount.

The method then receives (at 915) performance scores for the various categories or keywords in the user profile (e.g., from an aggregated performance database). In some embodiments, a performance score is based on a category and a user interest score for the category. In other embodiments, a performance score is based on a keyword and a user interest score for the keyword. Using the received performance scores, the method determines (at 920) a performance score for each category or keyword in the user profile.

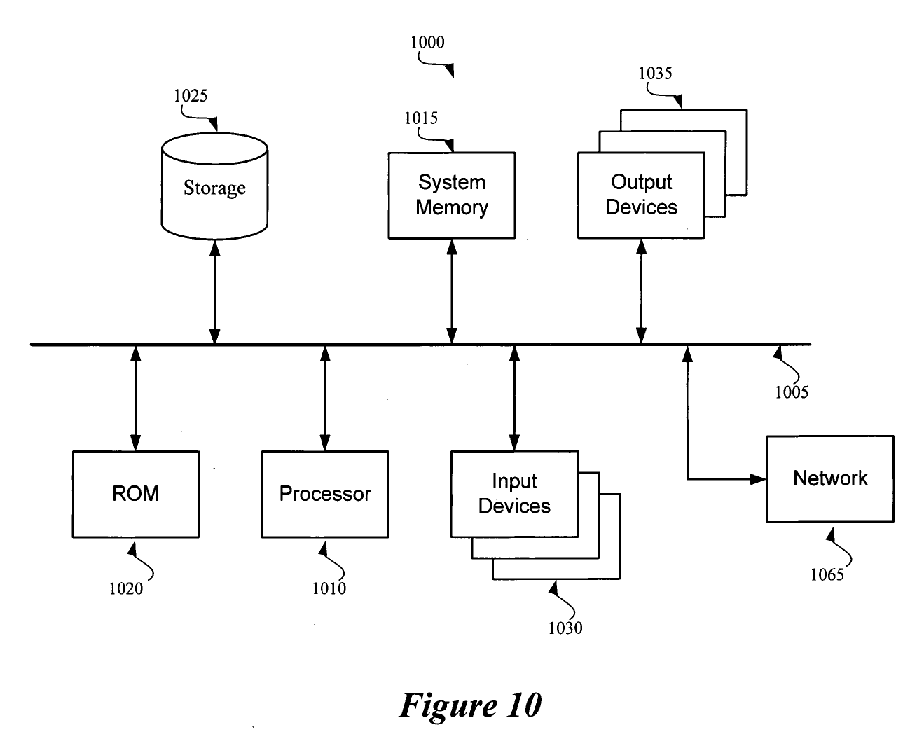

The method then receives (at 925) a revenue amount associated with each category or keyword in the user profile. The method determines (at 930) an expected revenue amount for each category or keyword in the user profile (e.g., by multiplying the performance score and revenue amount for each category or keyword). The method then selects (at 935) additional content to be sent to the client system/user based on the expected revenue amounts. For example, the method may select the additional content associated with the category or keyword in the user profile having the highest expected revenue amount. The method then retrieves and sends (at 940) the requested base content and the selected additional content to the client system/user. For example, the method may retrieve the base content from a base content server and the additional content from an additional content server. The method 900 then ends. ]FIG. 10 presents a computer system 1000 with which some embodiments are implemented. The computer system 1000 includes a bus 1005, a processor 1010, a system memory 1015, a read-only memory 1020, a permanent storage device 1025, input devices 1030, and output devices 1035.

The bus 1005 collectively represents all system, peripheral, and chipset buses that communicatively connect the numerous internal devices of the computer system 1000. For instance, the bus 1005 communicatively connects the processor 1010 with the read-only memory 1020, the system memory 1015, and the permanent storage device 1025.

The read-only-memory (ROM) 1020 stores static data and instructions that are needed by the processor 1010 and other modules of the computer system. The permanent storage device 1025, on the other hand, is read-and-write memory device. This device is a non-volatile memory unit that stores instruction and data even when the computer system 1000 is off. Some embodiments use a mass-storage device (such as a magnetic or optical disk and its corresponding disk drive) as the permanent storage device 1025. Other embodiments use a removable storage device (such as a floppy disk or zip® disk, and its corresponding disk drive) as the permanent storage device.

Like the permanent storage device 1025, the system memory 1015 is a read-and-write memory device. However, unlike storage device 1025, the system memory is a volatile read-and-write memory, such as a random access memory (RAM). The system memory stores some of the instructions and data that the processor needs at runtime.

Instructions and/or data needed to perform methods of some embodiments are stored in the system memory 1015, the permanent storage device 1025, the read-only memory 1020, or any combination of the three. For example, the various memory units may contain instructions for selecting additional content and/or contain various data used to select the additional content. From these various memory units, the processor 1010 retrieves instructions to execute and data to process in order to execute the processes of some embodiments.

The bus 1005 also connects to the input and output devices 1030 and 1035. The input devices 1030 enable a user to communicate information and select commands to the computer system 1000. The input devices 1030 include alphanumeric keyboards and cursor-controllers. The output devices 1035 display images generated by the computer system 1000. For instance, these devices display a web browser through which the user can interface with the computer system 1000. The output devices include printers and display devices, such as cathode ray tubes (CRT) or liquid crystal displays (LCD).

Finally, as shown in FIG. 10, the bus 1005 also couples the computer system 1000 to a network 1065 through, for example, a network adapter (not shown). In this manner, the computer system 1000 can be a part of a network of computers (such as a local area network (“LAN”), a wide area network (“WAN”), or an Intranet) or a network of networks (such as the Internet). Any or all of the components of the computer system 1000 may be used in conjunction with some embodiments. However, one of ordinary skill in the art would appreciate that any other system configuration may also be used in conjunction with other embodiments.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A system for selecting additional content to send with base content requested by a user, the user having an associated user profile comprising two or more categories and an interest score corresponding to each category that reflects the user's interest in the corresponding category, each category having at least one associated additional content and an associated category revenue amount, the system comprising:
an optimizer module configured to:
identify a performance score for each category in the user profile, the performance score reflecting a probability that a user will select an additional content associated with the category upon viewing the additional content;
determine an expected revenue amount for each category in the user profile using the performance score of the category and the category revenue amount; and
select an additional content associated with a category in the user profile using the determined expected revenue amounts.

2. The system of claim 1, further comprising:
a client system used by the user, the client system being configured to send the request for base content, receive base content and additional content, and to display the base content and additional content; and
a base content server connected to the client system and the optimizer module, the base content server containing base content and being configured to receive the request for base content from the user, receive the selected additional content from the optimizer module, and to send the base content and selected additional content to the client system.

3. The system of claim 1, further comprising:
a user profile database connected to the optimizer module, the user profile database containing a plurality of user profiles associated with a plurality of users;
an aggregated performance database connected to the optimizer module, the aggregated performance database containing performance scores for a plurality of categories and a plurality of interest scores for each category, the performance score of a particular category and a particular interest score being determined statistically by determining the number of selections of additional content associated with the particular category per number of viewings of the additional content by users having the particular interest score in the particular category; and
an additional content revenue database connected to the optimizer module, the additional content revenue database containing bid amounts from advertisers for additional content associated with a plurality of categories.

4. The system of claim 3, further comprising:
a client system used by the user, the client system being configured to receive and display base content and additional content, to receive selections of additional content from the user, and to send performance data regarding the number of times additional content has been displayed and selected; and
a processing server connected to the client system and the aggregated performance database for receiving and collecting the performance data from the client system, the collected performance data being used to update one or more performance scores of the aggregated performance database.

5. The system of claim 1, further comprising:
a user profile database connected to the optimizer module, the user profile database containing a plurality of user profiles associated with a plurality of users;
an aggregated performance database connected to the optimizer module, the aggregated performance database containing performance scores for a plurality of categories and a plurality of behavior parameters, the performance scores being determined statistically by determining the number of selections of additional content associated with the particular category per number of viewings of the additional content by users meeting the behavior parameters; and
an additional content revenue database connected to the optimizer module, the additional content revenue database containing bid amounts from advertisers for additional content associated with a plurality of categories.

6. The system of claim 1, wherein the optimizer module is further configured to:
receive the user profile from the user profile database;
receive performance scores for the categories and interest scores in the user profile from the aggregated performance database; and
receive category revenue amounts for the categories in the user profile from the additional content revenue database.

7. The system of claim 1, wherein a category revenue amount for a category reflects the average revenue amount generated per each user selection of an additional content associated with the category.

8. The system of claim 7, wherein:
a category has an associated set of keywords, each keyword having an associated additional content and an associated revenue amount that reflects a revenue generated by each user selection of the associated additional content; and
the average revenue amount generated for a category is determined using rates of occurrence of keywords of the category relative to the other keywords in the category.

9. The system of claim 1, wherein the optimizer module is configured to determine the expected revenue amount for each category in the user profile by multiplying the performance score of the category and the category revenue amount.

10. A method for selecting additional content to send with base content requested by a user, the user having an associated user profile comprising two or more categories and an interest score corresponding to each category that reflects the user's interest in the corresponding category, each category having at least one associated additional content and an associated category revenue amount, the method comprising:
identifying a performance score for each category in the user profile, the performance score reflecting a probability that a user having the corresponding interest score in the category will select an additional content associated with the category upon viewing the additional content;
determining an expected revenue amount for each category in the user profile using the performance score of the category and the category revenue amount; and
selecting an additional content associated with a category in the user profile using the determined expected revenue amounts.

11. The method of claim 10, further comprising:
sending the requested base content and the selected additional content to a client system used by the user, the client system being configured to display the base content and additional content.

12. The method of claim 10, further comprising:
receiving the user profile from a user profile database containing a plurality of user profiles associated with a plurality of users;
receiving performance scores for the categories and interest scores in the user profile from an aggregated performance database containing performance scores for a plurality of categories and a plurality of interest scores for each category, the performance score of a particular category and a particular interest score being determined statistically by determining the number of selections of additional content associated with the particular category per number of viewings of the additional content by users having the particular interest score in the particular category; and
receiving category revenue amounts for the categories in the user profile from an additional content revenue database containing bid amounts from advertisers for additional content associated with a plurality of categories.

13. The method of claim 12, further comprising:
sending the requested base content and the selected additional content to a client system used by the user, the client system being configured to receive and display base content and additional content, to receive selections of additional content from the user, and to send performance data regarding the number of times additional content has been displayed and selected; and
sending performance data from the client system to a processing server configured for receiving and collecting the performance data, the collected performance data being used to update one or more performance scores of the aggregated performance database.

14. The method of claim 10, further comprising:
receiving the user profile from a user profile database containing a plurality of user profiles associated with a plurality of users;
receiving performance scores for the categories and interest scores in the user profile from an aggregated performance database containing performance scores for a plurality of categories and a plurality of behavior parameters, the performance scores being determined statistically by determining the number of selections of additional content associated with the particular category per number of viewings of the additional content by users meeting the behavior parameters; and
receiving category revenue amounts for the categories in the user profile from an additional content revenue database containing bid amounts from advertisers for additional content associated with a plurality of categories.

15. The method of claim 10, wherein a category revenue amount for a category reflects the average revenue amount generated per each user selection of an additional content associated with the category.

16. The method of claim 15, wherein:
a category has an associated set of keywords, each keyword having an associated additional content and an associated revenue amount that reflects a revenue generated by each user selection of the associated additional content; and
the average revenue amount generated for a category is determined using rates of occurrence of keywords of the category relative to the other keywords in the category.

17. The method of claim 10, wherein determining the expected revenue amount for each category in the user profile comprises multiplying the performance score of the category and the category revenue amount for each category in the user profile.

18. A system for selecting additional content to send with base content requested by a user, the user having an associated user profile comprising two or more keywords and an interest score corresponding to each keyword that reflects the user's interest in the corresponding keyword, each keyword having an associated additional content and an associated keyword revenue amount, the system comprising:
an optimizer module configured to:
identify a performance score for each keyword in the user profile, the performance score reflecting a probability that a user having the corresponding interest score in the keyword will select an additional content associated with the keyword upon viewing the additional content;
determine an expected revenue amount for each keyword in the user profile using the performance score of the keyword and the keyword revenue amount; and
select an additional content associated with a keyword in the user profile using the determined expected revenue amounts.

19. The system of claim 18, wherein:
a performance score of a particular keyword and a particular interest score is determined statistically by determining the number of selections of the additional content associated with the particular keyword per number of viewings of the additional content by users having the particular interest score in the particular keyword;
the keyword revenue amount associated with a keyword reflects a revenue generated by each user selection of the additional content associated with the keyword; and
the optimizer module is configured to determine the expected revenue amount for each keyword in the user profile by multiplying the performance score of the keyword and the keyword revenue amount.

20. A method for selecting additional content to send with base content requested by a user, the user having an associated user profile comprising two or more keywords and an interest score corresponding to each keyword that reflects the user's interest in the corresponding keyword, each keyword having an associated additional content and an associated keyword revenue amount, the method comprising:
identifying a performance score for each keyword in the user profile, the performance score reflecting a probability that a user having the corresponding interest score in the keyword will select an additional content associated with the keyword upon viewing the additional content;
determining an expected revenue amount for each keyword in the user profile using the performance score of the keyword and the keyword revenue amount; and
selecting an additional content associated with a keyword in the user profile using the determined expected revenue amounts.

21. The method of claim 20, wherein:
a performance score of a particular keyword and a particular interest score is determined statistically by determining the number of selections of the additional content associated with the particular keyword per number of viewings of the additional content by users having the particular interest score in the particular keyword;
the keyword revenue amount associated with a keyword reflects a revenue generated by each user selection of the additional content associated with the keyword; and
determining the expected revenue amount for each keyword in the user profile comprises multiplying the performance score of the keyword and the keyword revenue amount for each keyword in the user profile.
